(19) United States
(12) Patent Application Publication
(10) Pub. No.: US 2011/0243331 A1
(43) Pub. Date: Oct. 6, 2011

(54) SHARED RANDOM NUMBERS MANAGEMENT METHOD AND MANAGEMENT SYSTEM IN SECRET COMMUNICATION NETWORK

(75) Inventors: Wakako Yasuda, Tokyo (JP); Akio Tajima, Tokyo (JP); Akihiro Tanaka, Tokyo (JP); Seigo Takahashi, Tokyo (JP)

(73) Assignee: NEC CORPORATION, Tokyo (JP)

(21) Appl. No.: 13/133,844

(22) PCT Filed: Dec. 3, 2009
(86) PCT No.: PCT/JP2009/006586

§ 371 Date: Jun. 9, 2011

(30) Foreign Application Priority Data
Dec. 10, 2008 (JP) 2008-314239

(51) Int. Cl. H04L 9/08; H04L 9/00

(52) U.S. Cl. 380/279; 380/277; 380/46

(57) ABSTRACT

In a secret communication network including a center node and multiple remote nodes, the center node is provided with a virtual remote node which functions as a remote node similar to each of the remote nodes. Random numbers shared between the center node and each remote node are managed based on random number sequences used in cipher communication between the virtual remote node and one of the remote nodes.

### TECHNICAL FIELD

This application is based upon and claims the benefit of priority from Japanese Patent Application No. 2008-314239, filed on Dec. 10, 2008, the disclosure of which is incorporated herein in its entirety by reference.

The present invention relates to a secret communication network and, more particularly, to a method and system for managing shared random numbers such as a cryptographic key to be used between nodes.

### BACKGROUND ART

The Internet is an economic and social infrastructure over which various kinds of data are exchanged, and therefore it is an important issue to provide for preventive measures to protect data flowing over the network from risks of eavesdropping. A secret communication system, in which data for communication is encrypted, can be cited as one of the preventive measures. There are two broad types of cryptography methods: common key cryptography and public key cryptography.

The common key cryptography is a method using a common key for both encryption and decryption, as typified by AES (Advanced Encryption Standard). This method enables high-speed processing and is therefore used to encrypt data itself.

The public key cryptography, on the other hand, is a method using a one-way function, as typified by the RSA (Rivest, Shamir, Adleman) encryption algorithm. According to this method, encryption is performed by using a public key, and decryption is performed by using a private key. This method is used to distribute a cryptographic key for common key cryptography and the like because it is not suitable for high-speed processing.

In secret communication that ensures secrecy by encrypting data, one of the important things to ensure secrecy is that encrypted data will not be broken even if the encrypted data is intercepted by an eavesdropper. Therefore, it is necessary that the same cryptographic key should not be used consecutively to encrypt data. This is because, if the same cryptographic key is consecutively used for encryption, the possibility is increased that the cryptographic key is estimated based on the increased amount of intercepted data.

Accordingly, it is required to update a cryptographic key shared between a sending side and a receiving side. When updating a key, it is absolutely necessary that the key to be updated should not be intercepted or broken. To this end, there are two broad types of methods: (1) a method by which a key is encrypted by means of public key encryption and then transmitted, and (2) a method by which a key is encrypted by using a master key that is a common key preset for key update and then transmitted (for example, see Japanese Patent Application Unexamined Publication Nos. 2002-344438 (Patent Document 1) and 2002-300158 (Patent Document 2)). Security according to these methods depends on the fact that an enormous amount of calculation is required for cryptanalysis.

On the other hand, quantum key distribution (QKD) is a technology by which a cryptographic key is generated and shared between a sending side and a receiving side by transmission of a single photon per bit, unlike ordinary optical communication (see Non-patent Documents 1 and 2). Such a QKD technology ensures security not based on the amount of calculation as mentioned above but based on the quantum mechanics, and it has been proved that eavesdropping on the part of photon transmission is impossible. Moreover, not only the proposals to realize one-to-one key generation and sharing, but also proposals have been made to realize one-to-many key generation and sharing, or many-to-many key generation and sharing, by using an optical switching technique and a passive optical branching technique (see Non-patent Document 3).

According to the QKD technology as described above, since original information for a cryptographic key is transmitted by being superimposed on each of single photons, it is possible to continue generating a cryptographic key as long as photon transmission is performed. For example, it is possible to generate several tens kilobits of final key per second.

Furthermore, perfectly secure cipher communication can be provided by using a cryptographic key generated by the QKD technology for a one-time pad (OTP) cipher, which has been proved to be unbreakable. When cipher communication is performed by using an OTP cipher, a cryptographic key is consumed as much as the quantity of data and is always discarded once it is used. For example, when a 1-Mbit file is OTP-encrypted, transmitted, and received, a 1-Mbit cryptographic key is consumed.

As described above, in a cryptographic system in which cryptographic keys are generated and consumed in large quantities, it is indispensable to manage the cryptographic keys stored in storage media. In the QKD technology in particular, it is important to manage cryptographic keys among multiple nodes, in order to realize expansion to one-to-many or many-to-many key generation and sharing by using an optical switching technique and/or a passive optical branching technique as proposed in Non-patent Document 3.

### CITATION LIST

### Patent Literature

[Patent Document 1]

Japanese Patent Application Unexamined Publication No. 2002-344438

[Patent Document 2]

Japanese Patent Application Unexamined Publication No. 2002-300158

### Non Patent Literature

[Non-patent Document 1]

Bennett, C. H., and Brassard, G., “QUANTUM CRYPTOGRAPHY:

PUBLIC KEY DISTRIBUTION AND COIN TOSSING,” IEEE International Conference on Computers, Systems, and Signal Processing, Bangalore, India, Dec. 10-12, 1984, pp. 175-179

[Non-patent Document 2]

Ribordy, G., Gautier, J. -D., Gisin, N., Guinnard, O., and Zbinden, H., “Automated ‘plug & play’ quantum key distribution,” Electronics Letters, 1998, Vol. 34, No. 22, pp. 2116-2117.

[Non-patent Document 3]

Townsend, P. D., “Quantum cryptography on multiuser optical fibre Networks,” Nature, Jan. 2, 1997, Vol. 385, pp. 47-49).

[Non-patent Document 4]

Tanaka, A., Tomita, A., Tajima, A., Takeuchi, T., Takahashi, S., and Nambu, Y., “Temperature independent QKD system using alternative-shifted phase modulation method” in Proceedings of ECOC 2004, Tu.4.5.3.

### SUMMARY OF INVENTION

### Technical Problem

However, conventional technologies place importance only on generation of shared information such as a cryptographic key, and management of the shared information even considering consumption of the shared information has hardly been performed. As described above, the amount of a stored cryptographic key at each node is increased as key generation and sharing processes are performed, while the stored key is consumed and decreased in amount each time cipher communication is performed. In addition, key generation rates are not uniform among nodes in general because the key generation rate, at which a cryptographic key is generated through key generation and sharing processes, depends also on the distance between nodes, the quality of communication, and the like. Therefore, the amount of a stored key at each node is increased/decreased from moment to moment. As the number of nodes increases, management of cryptographic keys becomes more complicated.

When OTP (One-Time Pad) cipher communication is performed in particular, a key once used for encryption cannot be used for decryption, unlike a case where a key with a fixed length is reused. Therefore, it is necessary to manage keys for encryption and keys for decryption separately. This necessity causes the new problem that management is doubly complicated.

Accordingly, an object of the present invention is to provide a shared random numbers management method and system by which random numbers generated and consumed among a center node and a plurality of remote nodes can be securely and easily managed.

### Solution to Problem

A shared random numbers management system according to the present invention is a system which manages random numbers shared between a center node and each of a plurality of remote nodes connected to the center node in a secret communication network, characterized in that the center node comprises a virtual remote node which functions as a remote node similar to each of the plurality of remote nodes, wherein the random numbers are managed based on random number sequences used in cipher communication between the virtual remote node and one of the plurality of remote nodes.

A shared random numbers management method according to the present invention is a method which manages random numbers shared between a center node and each of a plurality of remote nodes connected to the center node in a secret communication network, characterized by: at the center node, providing a virtual remote node which functions as a remote node similar to each of the plurality of remote nodes; and managing the random numbers based on cipher communication between the virtual remote node and one of the plurality of remote nodes.

A shared random numbers management system according to the present invention is a secret communication network characterized by: at least one center node; a plurality of remote nodes connected to the center node; and a random number management section, wherein the center node comprises a virtual remote node which functions as a remote node similar to each of the plurality of remote nodes, wherein the random number management section manages the random numbers based on random number sequences used in cipher communication between the virtual remote node and one of the plurality of remote nodes.

A node according to the present invention is a node connected to a plurality of remote nodes in a secret communication network, characterized by: a virtual remote node which functions as a remote node similar to each of the plurality of remote nodes; and a manager for managing the random numbers based on random number sequences used in cipher communication between the virtual remote node and one of the plurality of remote nodes.

### Advantageous Effects of Invention

According to the present invention, random numbers generated and consumed among a center node and a plurality of remote nodes can be securely and easily managed.

### BRIEF DESCRIPTION OF DRAWINGS

FIG. 1 is a network diagram schematically showing a physical structure of a secret communication network to which a shared random number management system according to an exemplary embodiment of the present invention is applied.

FIG. 2 is a schematic diagram for describing a functional configuration of a key management system in a quantum key distribution network according to the present exemplary embodiment.

FIG. 3 is a schematic diagram for describing a key sharing procedure in the key management system shown in FIG. 2.

FIG. 4 is a block diagram showing a schematic configuration and structure of a quantum key distribution network according to a first example of the present invention.

FIG. 5 is a block diagram showing an example of a plug and play QKD system to which the present example is applied.

FIG. 6 is a schematic diagram for describing a procedure of sharing logically secure keys used for a remote node RN(1) to transmit encrypted data to a remote node NR(2) and a virtual remote node RN(3).

FIG. 7 is a schematic diagram for describing a procedure of sharing logically secure keys used for the remote node RN(2) to transmit encrypted data to the remote node RN(1) and virtual remote node RN(3).

FIG. 8 is a schematic diagram for describing a procedure of sharing logically secure keys used for the virtual remote node RN(3) to transmit encrypted data to the remote nodes RN(1) and RN(2).

FIG. 9 is a network diagram schematically showing a physical structure of a secret communication network to which a shared random number management system according to a modification example of the present exemplary embodiment is applied.

FIG. 10 is a network diagram schematically showing a physical structure of a secret communication network to which a shared random number management system according to another modification example of the present exemplary embodiment is applied.

### DESCRIPTION OF EMBODIMENTS

The present invention can be applied to a secret communication network, and shared random numbers are secret information shared between nodes. Hereinafter, a system enabling nodes to share random number sequences and perform cipher communication will be described in detail, taking a quantum key distribution network as an example of a secret communication network.

### 1. EXEMPLARY EMBODIMENT

### 1.1) Network Structure

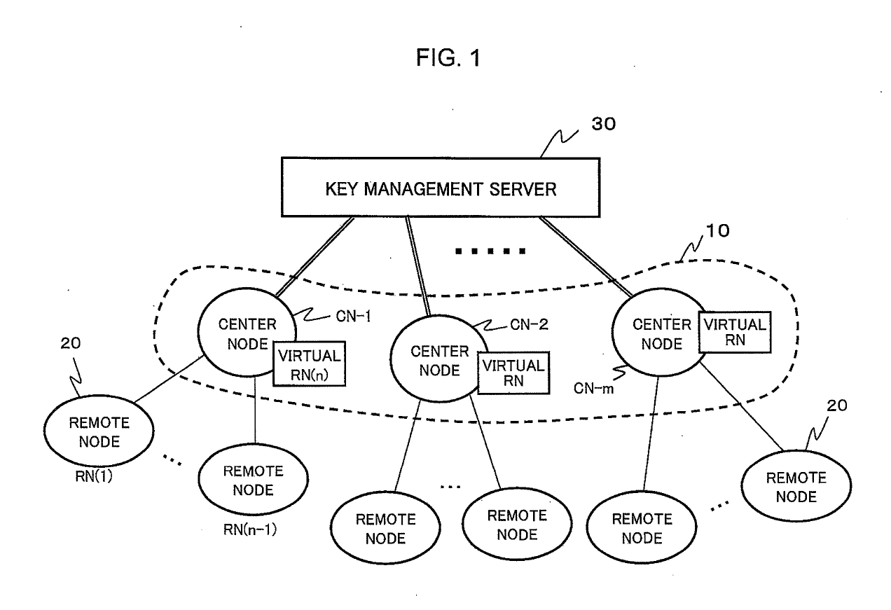

FIG. 1 is a network diagram schematically showing a physical structure of a secret communication network to which a shared random number management system according to an exemplary embodiment of the present invention is applied. Here, it is assumed that the secret communication network is composed of a plurality of one-to-many connection networks, each of which includes a center node and multiple remote nodes and is structured as a quantum key distribution network.

The secret communication network includes a center node group 10 including a plurality of center nodes CN-1 to CN-m, a plurality of remote nodes RN(1) to RN(n−1) connected to each center node, virtual remote nodes RN(n) provided on the center node side, and a key management server 30 that manages cryptographic keys at each center node.

The center node group 10 is formed in such a manner that the center nodes CN-1 to CN-m are managed by the key management server 30. Here, it is assumed that each center node is securely connected to the key management server 30 by a closed communication channel (indicated by double solid lines in FIG. 1).

At least one virtual remote node RN is deployed in the center node group 10. In the present exemplary embodiment, it is assumed that one virtual remote node is deployed in each center node and that multiple remote nodes are physically connected to each center node. Hereinafter, the multiple remote nodes physically connected to one center node will be denoted by RN(1) to RN(n−1), and the virtual remote node provided within the center node will be denoted by RN(n).

The virtual remote node RN(n) includes a quantum key pool and a secure key pool similar to those of the other remote nodes RN(1) to RN(n−1), which will be described later. Note that the virtual remote node RN(n) does not need to be physically provided but can be created by software on a program-controlled processor such as a CPU, using a required memory area. Moreover, since the virtual remote node RN(n) is provided within the center node, the virtual remote node RN(n), unlike the other remote nodes, does not need to generate a quantum key through quantum key generation and sharing processes with the center node. It is sufficient that, under management by the key management server 30, the virtual remote node RN(n) stores, in the quantum key pool, random numbers generated by a random number generator in the center node, which will be described in detail later.

The structure of each quantum key distribution network can be logically recognized as a 1:N structure in which the multiple (n−1) remote nodes RN(1) to RN(n−1) are connected to the single center node CN. Therefore, the actual physical network shown in FIG. 1 can be regarded as a group of 1:(n−1) networks. Accordingly, hereinafter, a description will be given of a case where a key management system according to the present exemplary embodiment is applied to a 1:(n−1) network including one center node and multiple remote nodes.

### 1.2) Key Management System

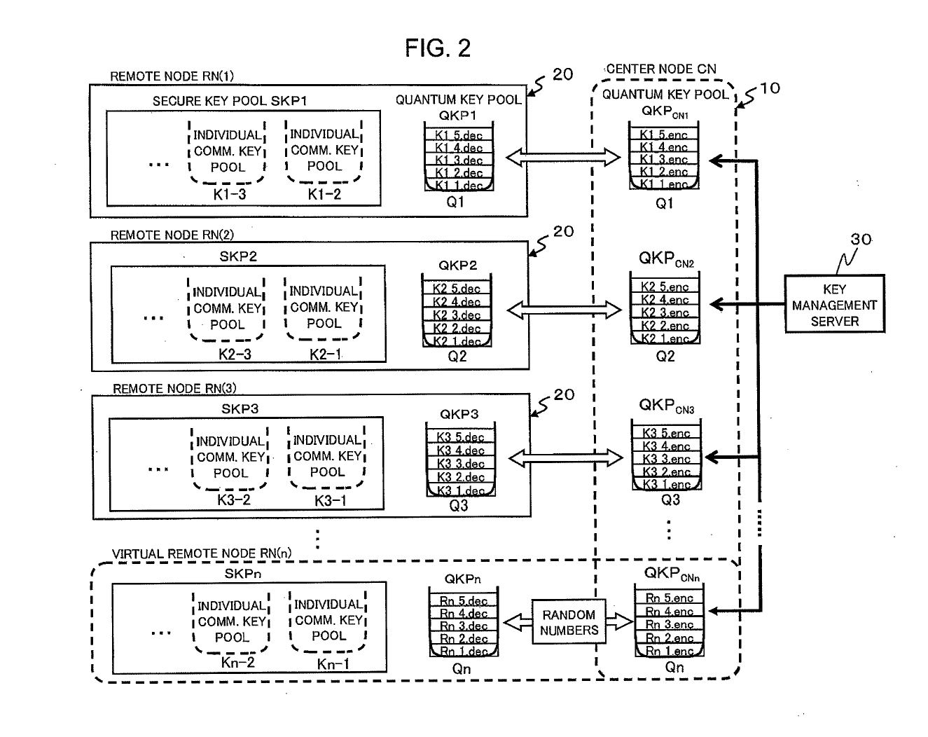

FIG. 2 is a schematic diagram for describing a functional configuration of the key management system in the quantum key distribution network according to the present exemplary embodiment. The key management system includes a center node CN, (n−1) remote nodes RN(1) to RN(n−1), a virtual remote node RN(n), and a key management server 30.

It is assumed that a quantum key Q generated through a quantum key distribution process is shared between the center node CN and each of the remote nodes RN(1) to RN(n−1). Such a quantum key Q is also referred to as shared random numbers or shared random number sequences. Each remote node is provided with a quantum key pool QKP, in which the quantum key Q shared with the center node CN is stored. For example, stored in the quantum key pool QKP1 of the remote node RN(1) is the quantum key Q1 associated with an identical quantum key Q1 in a corresponding quantum key pool QKP_{CN1} of the center node CN.

Moreover, each remote node is provided with a secure key pool SKP, where keys are stored in individual communication key pools K provided correspondingly to other remote nodes with which OTP cipher communication is to be performed. Through an undermentioned procedure of sharing a logically secure key, a remote node shares a key (random number sequence) to use for communication with another remote node and stores the key in the individual communication key pool K provided for this another remote node. Thereby, cipher communication between the remote nodes can be performed. For example, when cipher communication is performed between the remote nodes RN(1) and RN(3), a logically secure key is stored in the individual communication key pool K1-3 at the remote node RN(1), and an identical logically secure key is stored in the individual communication key pool K3-1 at the remote node RN(3). To generalize it, when cipher communication is performed between remote nodes RN(i) and RN(j), a logically secure key is stored in the individual communication key pool Ki-j at the remote node RN(1), and an identical logically secure key is stored in the individual communication key pool Kj-i at the remote node RN(j).

More specifically, since the quantum key Q stored at each remote node and the quantum key stored in the corresponding quantum key pool QKP_{CN} at the center node CN are the same random number sequences, the contents of the quantum key pool QKP at each remote node are exactly the same as the contents of the corresponding quantum key pool QKP_{CN} at the center node CN.

However, hereinafter, it will be assumed for convenience that the quantum keys at the center node CN serve as encryption keys and the quantum keys at the remote nodes serve as decryption keys, and that the quantum keys are stored and managed in files of a certain size (for example, 32 bytes or the like) with a file number given to each file, as shown in FIG. 2.

For example, an “enc” extension is added to each key file in the quantum key pools QKP_{CN} at the center node CN, with file numbers given to the key files in order of generation, so that the names of the key files in, for example, the quantum key pool QKP_{CN} corresponding to the remote node RN(1) are K1_1.enc, K1_2.enc, and so on. Similarly, a “dec” extension is added to each key file in, for example, the quantum key pool QKP1 at the remote node RN(1), with file numbers given to the key files in order of generation, so that the names of the key files are K1_1.dec, K1_2.dec, and so on. Note, however, that “enc” and “dec” are mere extensions of convenience. Therefore, the key file K1_1.enc and the key file K1_1.dec, for example, are substantially the same random numbers sequences.

The virtual remote node RN(n), similarly to the remote nodes RN(1) to RN(n−1), is provided with a quantum key pool QKPn, in which a quantum key Qn shared with the center node CN is stored. However, since the virtual remote node RN(n) is set within the center node CN, the quantum key does not need to be generated through quantum key generation and sharing processes. Here, random numbers generated by the random number generator in the center node CN are stored in files, as described above, in the quantum key pool QKPn under the file names of Rn_1.dec, Rn_1.dec, and so on. Similarly, identical random numbers are also stored in a quantum key pool QKP_{CNn} of the center node CN under the file names of Rn_1.enc, Rn_2.enc, and so on.

Moreover, the virtual remote node RN(n) also is provided with a secure key pool SKPn, where keys are stored in individual communication key pools K provided correspondingly to other remote nodes with which OTP cipher communication is to be performed. For example, when cipher communication is performed with the remote node RN(1), a logically secure key is stored in the individual communication key pool Kn-1 provided for the remote node RN(1), and an identical logically secure key is stored in the individual communication key pool K1-n at the remote node RN(1).

In the following description, operations for remote nodes to securely share a key for use in cipher communication between the remote nodes will be referred to as “key distribution.” One of specific examples thereof is one-time pad (OTP) key distribution. A communication key shared between remote nodes through this key distribution will also be referred to as “logically secure key.”

### 1.3) Exemplary Key Sharing Between Center and Remote Nodes

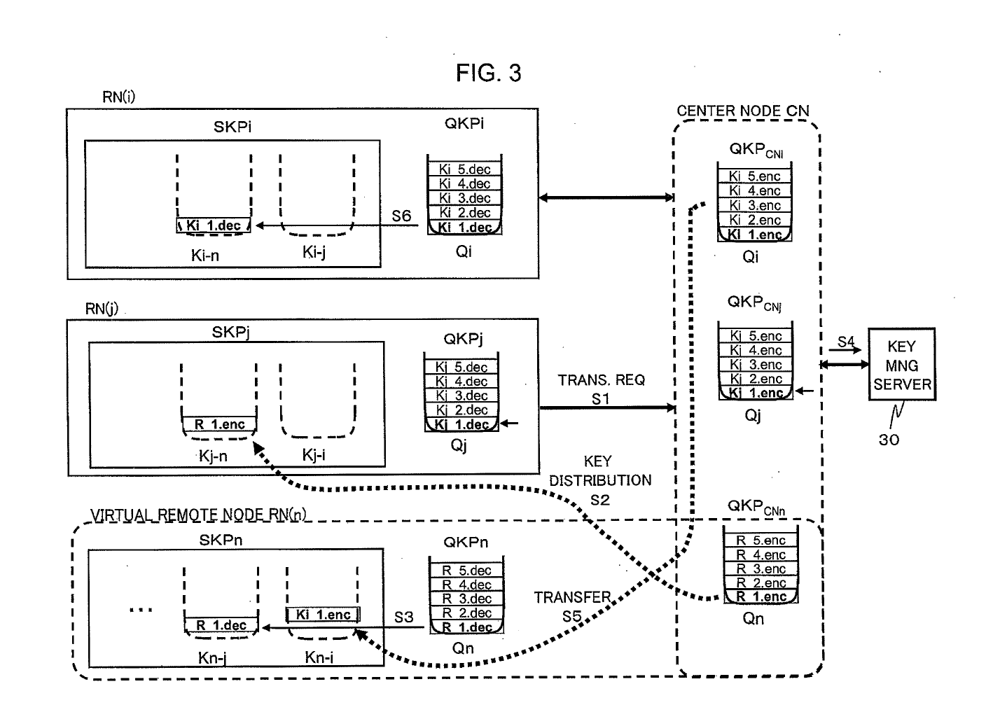

FIG. 3 is a schematic diagram for describing a key sharing procedure in the key management system shown in FIG. 2. Here, a description will be given of processes for sharing keys between the virtual remote node RN(n) and two remote nodes RN(i) and RN(j) (i and j are arbitrary different natural numbers not greater than n).

As an example, it is assumed that the remote node RN(j) makes a request to the key management server 30 for data transmission to the center node CN (transmission request S1). The key management server 30 controls the quantum key pool QKP_{CNj} corresponding to the remote node RN(j), which is the source of the transmission request S1, and the quantum key pool QKP_{CNn} corresponding to the virtual remote node RN(n) in the center node CN, which is the destination, thereby starting an encryption/decryption key sharing process so that data can be transmitted from the source remote node RN(j) to the virtual remote node RN(n).

First, a key file R_1.enc in the quantum key pool QKP_{CNn} corresponding to the destination virtual remote node RN(n) is OTP-distributed to the individual communication key pool Kj-n at the source remote node RN(j) (key distribution S2). That is, the key file R_1.enc to be distributed is encrypted by using a key file Kj_1.enc in the quantum key pool QKP_{CNj} corresponding to the source and is decrypted by using an identical key file Kj_1.dec in the quantum key pool QKPj at the remote node RN(j).

Simultaneously, at the virtual remote node RN(n), a key file R_1.dec in the quantum key pool QKPn is transferred to the individual communication key pool Kn-j (transfer S3).

As described above, since the key file R_1.enc in the quantum key pool QKP_{CNn} at the center node CN is the same as the key file R_1.dec in the quantum key pool QKPn at the virtual remote node RN(n), it can be said that the same logically secure keys have been stored in the individual communication key pool Kj-n at the sending-side remote node RN(j) and in the individual communication key pool Kn-j at the virtual remote node RN(n), respectively. Thus, the remote node RN(j) encrypts data for transmission by using the key file R_1.enc (logically secure key) and transmits the data to the center node CN, and the virtual remote node RN(n) that has received this encrypted data can decrypt the received data by using the identical key file R_1.dec (logically secure key).

Conversely, it is assumed that the center node CN makes a request to the key management server 30 for data transmission to the remote node RN(i) (transmission request S4). The key management server 30 instructs the center node CN to transfer a key file Ki_1.enc in the quantum key pool QKP_{CNi} corresponding to the destination remote node RN(i) into the individual communication key pool Kn-i of the virtual remote node RN(n) (transfer S5). Since the virtual remote node RN(n) is set within the center node CN, encryption is not needed for transfer of the key file Ki_1.enc. However, a similar transfer process as in the case of the other remote nodes can also be used.

Simultaneously, at the remote node RN(i), a key file Ki_1.dec in the quantum key pool QKPi is transferred into the individual communication pool Ki-n (transfer S6).

As described above, since the key file Ki_1.enc in the quantum key pool QKP_{CNi} at the center node CN is the same as the key file Ki_1.dec in the quantum key pool QKPi at the remote node RN(i), it can be said that the same logically secure keys have been stored in the individual communication key pool Kn-i at the virtual remote node RN(n) and in the individual communication key pool Ki-n at the destination remote node RN(i), respectively.

Thus, the virtual remote node RN(n) encrypts data by using the key file Ki_1.enc (logically secure key) and transmits the data to the remote node RN(i), and the remote node RN(i) can decrypt the received encrypted data by using the identical key file Ki_1.dec (logically secure key).

### 1.4) Effects

According to the present exemplary embodiment, with the provision of a virtual remote node within a center node, communication between the center node and a remote node can be treated as communication between the virtual remote node and a remote node. Accordingly, the key management sever 30 can manage not only consumption of keys between remote nodes but also consumption of cryptographic keys used in communication between the center node and remote nodes similarly, only by monitoring the amounts of keys in the quantum key pools QKP_{CN1} to QKP_{CNn} within the center node CN. Thus, management of the keys for communication can be simplified.

Moreover, a quantum key pool and a secure key pool are provided to each remote node, and sharing of a logically secure key and consumption of a quantum key are performed in response to a request from a remote node. Thus, the center node can allocate time intervals in each of which a key generation process through QKD is performed, that is, time-divided durations to be allocated to individual remote nodes, depending on the amounts of keys stored in the quantum key pools.

Furthermore, quantum keys at the center node are used as encryption keys (or decryption keys) and quantum keys at remote nodes are used decryption keys (or encryption keys), and an encryption key is distributed to a remote node securely through OTP key distribution, whereby management of the encryption keys and decryption keys in OTP cipher communication can be simplified.

The use of the present scheme makes it possible that even if the amounts of communication are not symmetric between remote nodes performing OTP cipher communication, an encryption key and a decryption key can be shared independently of each other, depending on their respective consumptions.

Further, the secure key pool that stores logically secure keys in accordance with the number of remote nodes is provided, whereby keys can be easily managed by using the same scheme regardless of the number of remote nodes. Therefore, new participation or withdrawal of a remote node in/from the quantum key distribution network can be handled only by increasing or decreasing the number of individual communication key pools in the secure key pool. Thus, a change in the network can be easily made.

### 2. FIRST EXAMPLE

### 2.1) Configuration

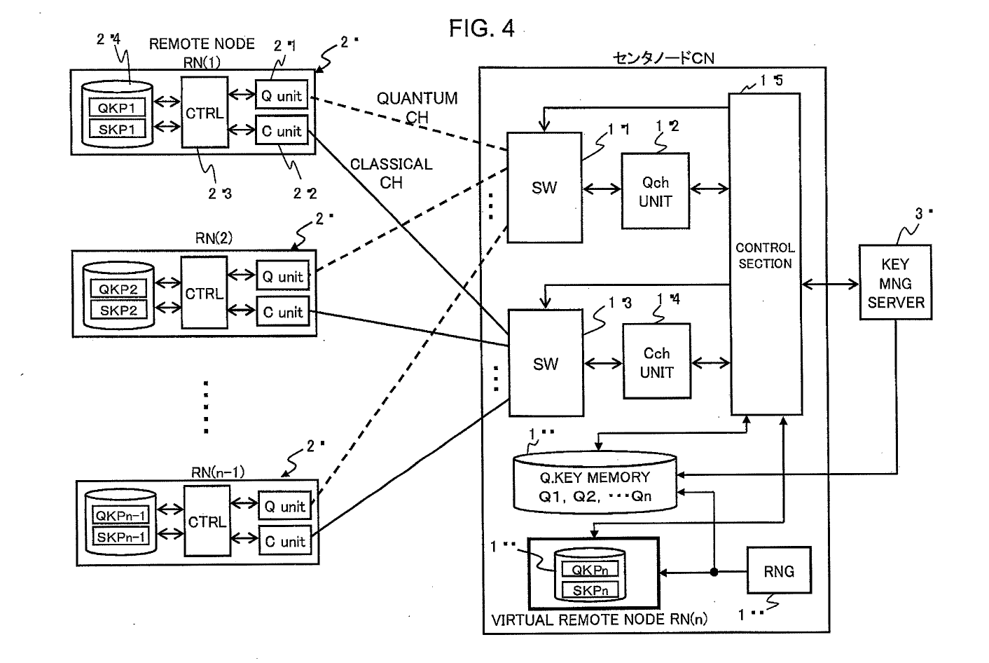

FIG. 4 is a block diagram showing a schematic configuration and structure of a quantum key distribution network according to a first example of the present invention. Here, shown is selected part of the network shown in FIG. 1, in which each of (n−1) remote nodes RN(1) to RN(n−1) is connected to a center node CN through optical fiber, and generation and sharing of a quantum key, as well as cipher communication using the quantum key, are performed between the center node CN and each remote node RN(i).

The remote nodes RN(1) to RN(n−1) have similar configurations, each including a quantum channel unit 201, a classical channel unit 202, a control section 203 controlling these units, and a key memory 204 for storing keys.

In the key memories 204 of the remote nodes RN(1) to RN(n−1), quantum key pools QKP₁ to QKPₙ₋₁ are provided, respectively, in which quantum keys Q1 to Qn-1 generated and shared between the center node CN and each remote node RN(i) are stored, respectively. Moreover, secure key pools SKP₁ to SKPₙ₋₁ are also provided in the key memories 204, respectively. In the secure key pool SKP₁, a logically secure key for use in one-time-pad cipher communication between remote nodes is stored on demand for each remote node.

The control section 203 performs generation of shared random numbers with the center node CN, encryption/decryption using the shared random numbers, and the like. The control section 203 may be a program-controlled processor, in which the above-described shared random number generation function and encryption/decryption function can be implemented by executing programs read from a memory (not shown).

The center node CN includes a quantum channel switch section 101, a quantum channel unit 102, a classical channel switch section 103, a classical channel unit 104, a control section 105 controlling these sections and units, and a quantum key memory 106 for storing keys. In the quantum key memory 106 of the center node CN, quantum key pools QKP_{CN1} to QKP_{CNn} are provided, in which shared random number keys Q1 to Qn shared with the remote nodes RN(1) to RN(n−1) and virtual remote node RN(n), respectively, are stored, respectively.

However, for the shared random number key Qn stored in the quantum key memory 106 as well as in the quantum key pool QKP_{CNn} of the virtual remote node RN(n), random numbers generated by a random number generator 107 are used. The provision of the virtual remote node RN(n) in the center node CN requires an additional memory 108 for storing the quantum key pool QKPₙ and secure key pool SKPₙ of the virtual remote node RN(n), as well as an additional memory area for storing the shared random number sequence Qn in the quantum key memory 106. However, this is not a great increase in the memory capacity. Moreover, for the memory 108 for storing the quantum key pool QKPₙ and secure key pool SKPₙ of the virtual remote node RN(n), it is also possible to assign a memory area other than the quantum key memory 106.

The control section 105 performs generation of shared random numbers with each of the remote nodes RN(1) to RN(n−1), management of the virtual remote node RN(n), switching control of the switch sections 101 and 103, encryption/decryption using the shared random numbers, monitoring of the amount of each key stored in the quantum key memory 106, and the like.

The quantum channel unit 201 of each remote node RN(i) and the quantum channel unit 102 of the center node CN generate a sequence of random numbers to be shared between the nodes in question by transmission of a very weak optical signal at a single-photon level or lower through a quantum channel and the quantum channel switch section 101. Moreover, the classical channel unit 202 of each remote nodes RN(i) and the classical channel unit 104 of the center node CN transmit/receive data, a file number, and the like to generate and share a sequence of random numbers through a classical channel and the classical channel switch section 103, and also transmit/receive data encrypted based on shared random numbers through the classical channel and the classical channel switch section 103.

The control section 105 can connect a quantum channel between a selected one of the remote nodes RN(1) to RN(n−1) and the center node CN to the quantum channel unit 102 by controlling the switch section 101. Independently of this quantum channel switching control, the control section 105 can connect a classical channel between a selected one of the remote nodes RN(1) to RN(n−1) and the center node CN to the classical channel unit 104 by controlling the switch section 103.

The key management server 30 monitors the quantum key memory 106 of the center node CN. In the example shown in FIG. 4, since there is only one center node, the key management server 30 monitors the quantum key memory 106 of the center node CN only.

Each remote node RN(i) stores a generated random number sequence in the quantum key pool QKP, of the key memory 204. The center node CN stores in the quantum key memory 106 all random number sequences respectively generated with the remote nodes RN(1) to RN(n−1). Moreover, for the share random number sequence Qn to be stored in each of the quantum key pool QKPₙ of the virtual remote node RN(n) and the quantum key memory 106, a random number sequence generated by the random number generator 107 is used. Since the center node CN keeps track of all of the quantum keys shared with the remote nodes under its jurisdiction in this manner, it is sufficient for the key management server 30 to monitor only the quantum key memory 106 of the center node CN.

Incidentally, it is sufficient that a quantum channel and a classical channel can be distinguished as different channels. The quantum channel is a channel used to generate a quantum key. The classical channel is a channel for communication in the ordinary optical power region and is used to transmit data for generating shared random numbers and to transmit encrypted data. Although the quantum channel transmits an optical signal in a very weak state of power equivalent to one photon per bit or fewer from a sender (Alice) to a receiver (Bob), the quantum channel can also transmit an optical signal of the optical power used in ordinary optical communication.

Moreover, in the present example, a quantum channel and a classical channel are multiplexed. However, the multiplexing method is not particularly specified. If a wavelength division multiplexing method is used, it is sufficient to make a configuration such that a signal of the quantum channel wavelength is demultiplexed to be input to the switch section 101 and a signal of the classical channel wavelength is demultiplexed to be input to the switch section 103, with a wavelength multiplexing/demultiplexing section being provided before the switch sections 101 and 103 correspondingly to each remote node.

### 2.2) Quantum Key Generation

The control section 105 of the center node CN and the control section 203 of each remote node RN(i) control the overall operation of their respective own nodes. Here, however, a key generation function will be particularly described. The control sections 105 and 203 carry out a predetermined key generation sequence, whereby a random number sequence is shared between the center node CN and each remote node RN(i). As a typical example, the control sections 105 and 203 carry out the BB84 protocol (see Non-patent document 1), as well as error detection and correction, and privacy amplification, thereby generating and sharing a key. As an example, a description will be given of a case of generating a random number sequence for the quantum key Q1 to be shared between the center node CN and the remote node RN(1).

First, the quantum channel unit 201 of the remote node RN(1) and the quantum channel unit 102 of the center node CN carry out single-photon transmission through a quantum channel. The quantum channel unit 102 of the center node CN performs photon detection and outputs the result of this detection to the control section 105. Based on the result of the photon detection, the control sections 105 and 203 of these nodes in question carry out processing for basis reconciliation, error correction, and privacy amplification through a classical channel. At the center node CN, the thus shared random number sequence Q1 is stored in the quantum key memory 106, associated with the remote node RN(1). Shared random number sequences Q2 to Qn-1 to be shared with the other remote nodes RN(2) to RN(n−1), respectively, are also generated sequentially through similar processes.

Any of the quantum channel unit 201 of the remote node RN(1) and the quantum channel unit 102 of the center node CN may serve as any of Alice (the sender of a very weak optical signal) and Bob (the receiver of the very weak optical signal). However, since Bob includes a photon detector, it is preferable that Bob is deployed at the center node CN, from the viewpoint of power consumption and monitoring control.

Next, as an example, a detailed description will be given of a case where the present example is applied to a QKD system in which quantum key distribution is performed by using a plug and play scheme for the quantum channel units.

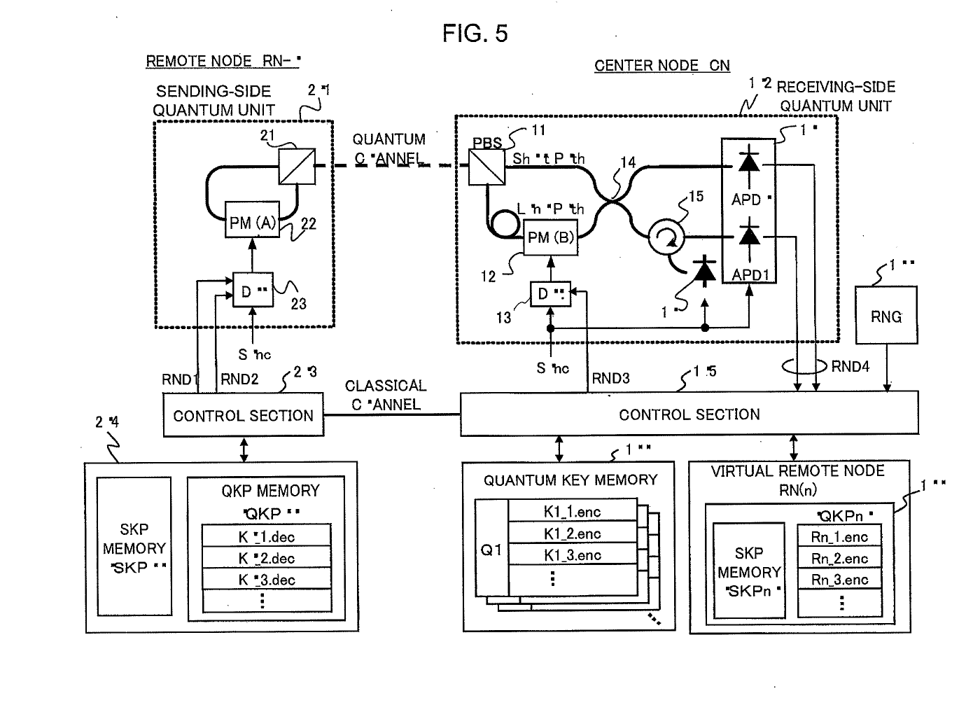

FIG. 5 is a block diagram showing an example of a plug and play QKD system to which the present example is applied. Here, it is assumed that the center node CN and an arbitrary remote node RN-x are connected through an optical fiber transmission line. Shown here are an example of the quantum channel unit 201 on Alice's side (remote node side) and an example of the quantum channel unit 102 on Bob's side (center node side). The quantum channel unit system in this example is based on an alternative-shifted phase modulation plug and play method (see Non-patent Documents 2 and 4).

In this example, the sending-side quantum channel unit 201 includes a polarization beam splitter (PBS) 21, a phase modulation section 22, and a driver section 23 and is connected to the optical fiber transmission line. The phase modulation section 22 and polarization beam splitter (PBS) 21 constitute a PBS loop. The PBS loop has a function similar to a Faraday mirror, outputting incident light with its polarization state rotated by 90 degrees (see Non-patent Document 4).

The phase modulation section 22 is driven by the driver section 23 to perform phase modulation on a series of passing optical pulses in accordance with a clock signal supplied from the classical channel unit. Four depths of phase modulation (0, π/2, π, 3π/2) are used here, which correspond to four possible combinations of random numbers RND1 and random numbers RND2 supplied from the control section 203. A phase modulation is performed at the timing when an optical pulse passes through the phase modulation section 22.

The receiving-side quantum channel unit 102 includes a polarization beam splitter (PBS) 11, a phase modulation section 12, a driver section 13, an optical coupler 14, an optical circulator 15, a photon detector 17, and a pulse light source 16 and is connected to the optical fiber transmission line. An optical pulse P generated by the pulse light source 16 in accordance with a clock signal supplied from the classical channel unit is led by the optical circulator 15 into the optical coupler 14, where the optical pulse P is split into two parts. One of the two parts, an optical pulse P1, is sent to the PBS 11 by traveling along a short path. The other part, an optical pulse P2, is sent to the PBS 11 after passing through the phase modulation section 12 provided in a long path. These optical pulses P1 and P2 are combined at the PBS 11 and then transmitted as double pulses to the quantum channel unit 201 on the sending side through the optical fiber transmission line.

In the sending-side quantum channel unit 201, the double pulses P1 and P2 arriving through the optical fiber transmission line are each further split into two parts, resulting in quartet pulses, that is, four pulses consisting of clockwise double pulses P1_{CW} and P2_{CW} and counterclockwise double pulses P1_{CCW} and P2_{CCW}. The clockwise double pulses P1_{CW} and P2_{CW} and counterclockwise double pulses P1_{CCW} and P2_{CCW} pass through the phase modulation section 22 in the opposite directions. Each pair enters a PBS port on the opposite side to the port from which the pair was output.

The phase modulation section 22 performs phase modulation on the following pulse P2_{CW} of the clockwise double pulses with respect to the preceding pulse P1_{CW} and also gives a phase difference of π between the counterclockwise double pulses and the clockwise double pulses. The quartet pulses thus phase-modulated as required are combined at the PBS 21 to return again to double pulses. The output double pulses will be represented by P1 and P2*^{a} since only the following pulse is phase-modulated according to transmission information as described above. At the time of output, the polarization of the output pulses has been rotated by 90 degrees with respect to the polarization at the time of input into the PBS loop. Consequently, an effect equivalent to that of a Faraday mirror can be achieved.

Since the polarization of the optical pulses P1 and P2*^{a} received from the quantum channel unit 201 has been rotated by 90 degrees, the PBS 11 of the receiving-side quantum channel unit 102 leads each of these received pulses into the different path than the path the pulse used at the time of transmission to the sending-side. Specifically, the received optical pulse P1 travels along the long path and is subjected at the phase modulation section 12 driven by the driver section 13 to phase modulation according to a random number RND3, resulting in a phase-modulated optical pulse P1*^{b} arriving at the optical coupler 14. On the other hand, the optical pulse P2*^{a} passes along the short path, which is different from the path the optical pulse P2 used at the time of transmission to the sending-side, and then arrives at the same optical coupler 14.

The optical pulse P2*^{a} thus phase-modulated at the quantum channel unit 201 and the optical pulse P1*^{b} thus phase-modulated at the quantum channel unit 102 interfere with each other, and the result of this interference is detected by the photon detector 17. The photon detector 17 is driven in the Geiger mode in accordance with a clock signal supplied from the classical channel unit and is thereby capable of high-sensitivity reception of a photon. Photon transmission is performed by the quantum channel units 201 and 102 as described above.

According to the present example, the control section 203 of the remote node RN-x and the control section 105 of the center node CN synchronize to each other through the classical channel. The sending-side quantum channel unit 201 transmits original information in frame units to the receiving-side quantum channel unit 102. Based on the information that the receiving-side quantum channel unit 102 has successfully received, random numbers to be shared between the remote node RN-x and center node CN are sequentially generated in file units of a predetermined size. The random number sequences thus matched to each other in file units are further associated with each other through the classical channel and then stored in a quantum key pool memory of the key memory 204 at the remote node RN-x and in the quantum key memory 106 at the center node CN, respectively.

Further, at the center node CN, random numbers generated by the random number generator 107 are stored, as random numbers in files shared with the virtual remote node RN(n), in the quantum key pool QKP_{CNn} of the quantum key memory 106 and in the quantum key pool QKPₙ of the virtual remote node RN(n).

In a system as shown in FIG. 5 in which a sender and a receiver independently generate cryptographic keys, it is guaranteed that the keys substantially concurrently generated by the sender and receiver are the same random number sequences. By subjecting the thus generated cryptographic keys to sharing processing by association as described above, it is possible to achieve sharing of a cryptographic key between the sender and receiver.

### 2.3) Key Management

Next, a description will be given of a key management method used when a logically secure key is shared between a center node and a remote node as well as between remote nodes by performing One-Time-Pad key distribution.

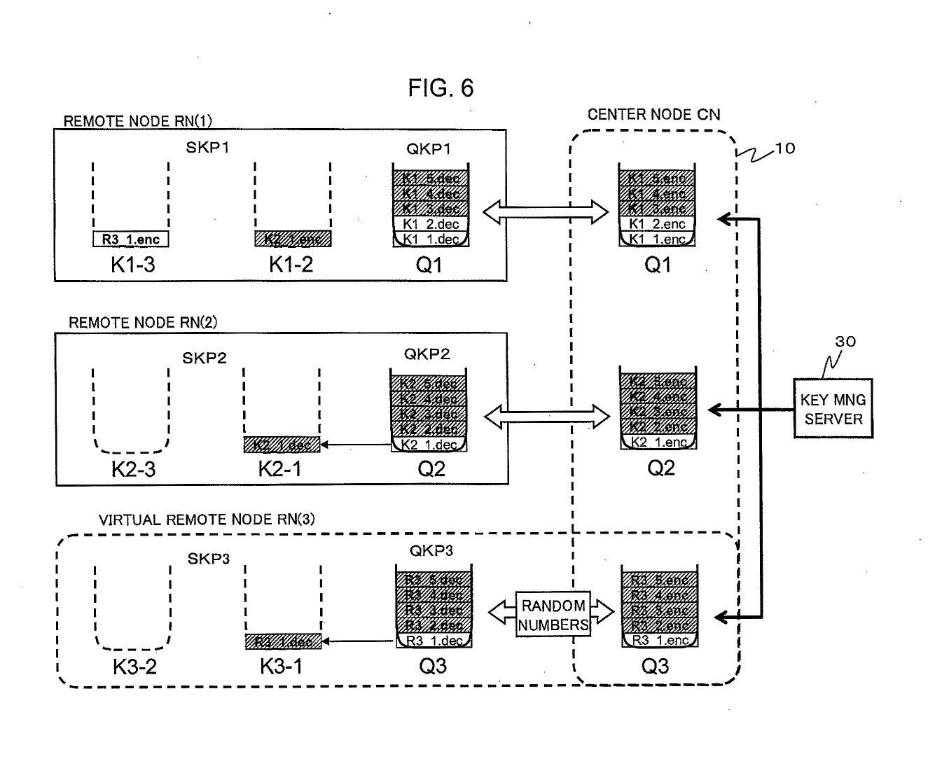

First, of n remote nodes, a node that is the source of encrypted data makes a request to the key management server 30 for a logically secure key of the destination. The shared logically secure key is stored in an appropriate individual communication key pool as an encryption key at the source, and as a decryption key at the destination, individually. Hereinafter, with reference to FIGS. 6 to 8, a procedure of sharing logically secure keys will be described more specifically in a case where n (the number of nodes) is three, of which two are actual remote nodes RN(1) and RN(2) and one is a virtual remote node RN(3) within a center node CN.

FIG. 6 is a schematic diagram for describing a procedure of sharing logically secure keys used for the remote node RN(1) to transmit encrypted data to the remote node RN(2) and virtual remote node RN(3). Upon receipt of a request from the remote node RN(1) for an encryption key with respect to the remote node RN(2), the key management server 30 instructs the center node CN to distribute an encryption key of the remote node RN(2) to the remote node RN(1). That is, the control section 105 of the center node CN OTP-encrypts a key file K2_1.enc of the quantum key Q2 by using a key file K1_1.enc of the quantum key Q1 and then transmits the OTP-encrypted key file K2_1.enc to the remote node RN(1). The control section 203 of the remote node RN(1) decrypts the key file K2_1.enc by using a key file K1_1.dec of its own quantum key Q1 and stores the key file K2_1.enc in the individual communication key pool K1-2. Moreover, the control section 203 of the remote node RN(2) relocates a key file K2_1.dec of its own quantum key Q2 into the individual communication key pool K2-1 as a decryption key. Thus, the key file K2_1.enc (encryption key) is distributed from the center node CN to the remote node RN(1), and the key files K1_1.enc and K1_1.dec of the quantum key Q1 are consumed.

Similarly, when the remote node RN(1) has made a request to the key management server 30 for an encryption key with respect to the virtual remote node RN(3), the key management server 30 instructs the center node CN to distribute an encryption key of the virtual remote node RN(3) to the remote node RN(1). That is, the control section 105 of the center node CN One-Time-Pad-encrypts a key file R3_1.enc of the quantum key Q3 by using a key file K1_2.enc of the quantum key Q1 and then transmits the OTP-encrypted key file R3_1.enc to the remote node RN(1). The control section 203 of the remote node RN(1) decrypts the key file R3 1.enc by using a key file K1_2.dec of its own quantum key Q1 and stores the key file R3_1.enc in the individual communication key pool K1-3. Moreover, the control section 105 relocates a key file R3_1.dec of the quantum key Q3 of the virtual remote node RN(3) into the individual communication key pool K3-1 as a decryption key. Thus, the key file R3_1.enc (encryption key) is distributed from the center node CN to the remote node RN(1), and the key files K1_2.enc and K1_2.dec of the quantum key Q1 are consumed.

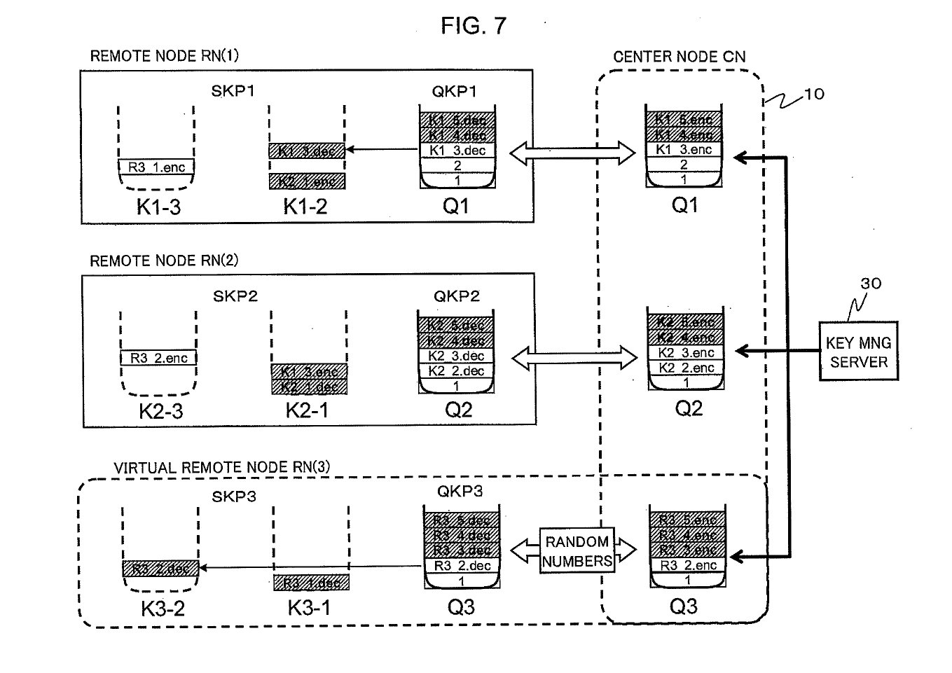

FIG. 7 is a schematic diagram for describing a procedure of sharing logically secure keys used for the remote node RN(2) to transmit encrypted data to the remote node RN(1) and virtual remote node RN(3). Upon receipt of a request from the remote node RN(2) for an encryption key with respect to the remote node RN(1), the key management server 30 instructs the center node CN to distribute an encryption key of the remote node RN(1) to the remote node RN(2). That is, the control section 105 of the center node CN One-Time-Pad-encrypts a key file K1_3.enc of the quantum key Q1 by using a key file K2_2.enc of the quantum key Q2 and then transmits the OTP-encrypted key file K1_3.enc to the remote node RN(2). The control section 203 of the remote node RN(2) decrypts the key file K1_3.enc by using a key file K2_2.dec of its own quantum key Q2 and stores the key file K1_3.enc in the individual communication key pool K2-1. Moreover, the control section 203 of the remote node RN(1) relocates a key file K1_3.dec of its own quantum key Q1 into the individual communication key pool K1-2 as a decryption key. Thus, the key file K1_3.enc (encryption key) is distributed from the center node CN to the remote node RN(2), and the key files K2_2.enc and K2_2.dec of the quantum key Q2 are consumed.

Similarly, when the remote node RN(2) has made a request to the key management server 30 for an encryption key with respect to the virtual remote node RN(3), the key management server 30 instructs the center node CN to distribute an encryption key of the virtual remote node RN(3) to the remote node RN(2). That is, the control section 105 of the center node CN OTP-encrypts a key file R3_2.enc of the quantum key Q3 by using a key file K2_3.enc of the quantum key Q2 and then transmits the OTP-encrypted key file R3_2.enc to the remote node RN(2). The control section 203 of the remote node RN(2) decrypts the key file R3_2.enc by using a key file K2_3.dec of its own quantum key Q2 and stores the key file R3_2.enc in the individual communication key pool K2-3. Moreover, the control section 105 relocates a key file R3_2.dec of the quantum key Q3 of the virtual remote node RN(3) into the individual communication key pool K3-2 as a decryption key. Thus, the key file R3_2.enc (encryption key) is distributed from the center node CN to the remote node RN(2), and the key files K2_3.enc and K2_3.dec of the quantum key Q2 are consumed.

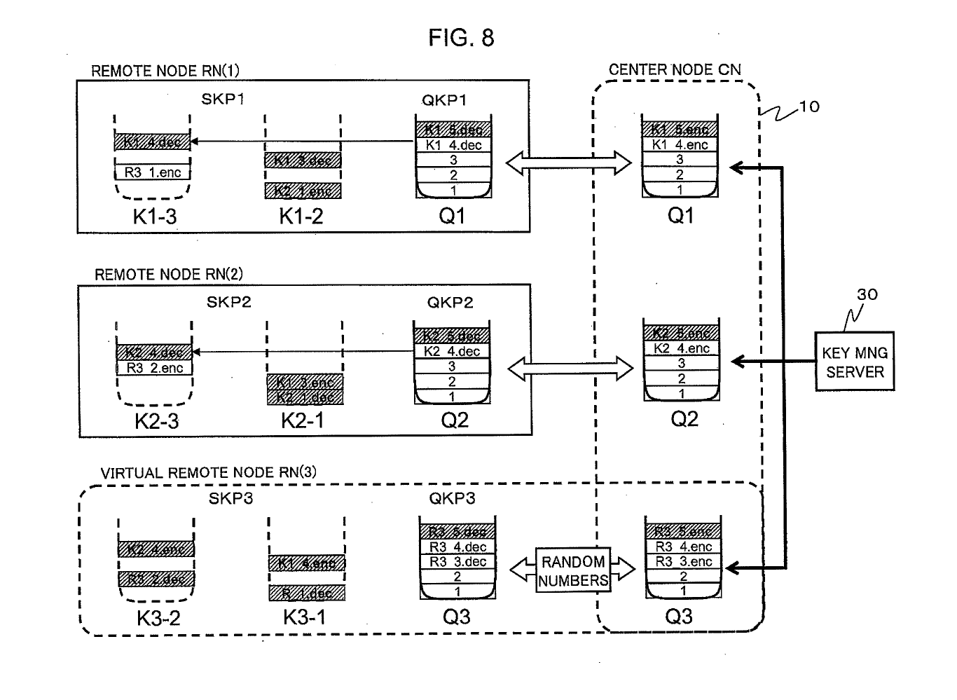

FIG. 8 is a schematic diagram for describing a procedure of sharing logically secure keys used for the virtual remote node RN(3) to transmit encrypted data to the remote nodes RN(1) and RN(2). Upon receipt of a request from the virtual remote node RN(3) for an encryption key with respect to the remote node RN(1), the key management server 30 instructs the center node CN to transfer an encryption key of the remote node RN(1) to the virtual remote node RN(3). That is, the control section 105 of the center node CN, after OTP-encrypting a key file K1_4.enc of the quantum key Q1 by using a key file R3_3.enc of the quantum key Q3, sends the OTP-encrypted key file K1_4.enc to the virtual remote node RN(3) in the center node CN. The control section 105 stores the key file K1_4.enc in the individual communication key pool K3-1. Moreover, the control section 203 of the remote node RN(1) relocates a key file K1_4.dec of its own quantum key Q1 into the individual communication key pool K1-3 as a decryption key. Thus, the key file K1_4.enc (encryption key) is transferred from the center node CN to the virtual remote node RN(3).

Similarly, upon receipt of a request from the virtual remote node RN(3) for an encryption key with respect to the remote node RN(2), the key management server 30 instructs the center node CN to transfer an encryption key of the remote node RN(2) to the virtual remote node RN(3). That is, the control section 105 of the center node CN, after One-Time-Pad-encrypting a key file K2_4.enc of the quantum key Q2 by using a key file R3_4.enc of the quantum key Q3, sends the One-Time-Pad-encrypted key file K2_4.enc to the virtual remote node RN(3) in the center node CN. The control section 105 stores the key file K2_4.enc in the individual communication key pool K3-2. Moreover, the control section 203 of the remote node RN(2) relocates a key file K2_4.dec of its own quantum key Q2 into the individual communication key pool K2-3 as a decryption key. Thus, the key file K2_4.enc (encryption key) is transferred from the center node CN to the virtual remote node RN(3).

Note that when the control section 105 of the center node CN sends a key file of a quantum key Q to the virtual remote node RN(3) within the center node CN, One-Time-Pad encryption is not needed because it is a transfer made within the center node CN. However, if the virtual remote node RN(3) is treated as the other remote nodes RN(1) and RN(2) are, it is not necessary to change transfer procedures depending on the type of remote node, bringing about the advantage that the control can be simplified.

### 2.4) Encryption Communication

Assuming that logically secure keys are stored in individual communication key pools at each remote node through the above-described logically secure key sharing process as shown in FIG. 8 for example, One-Time-Pad cipher communication between the remote nodes and between the center node and remote node is performed as follows.

When OTP cipher communication is performed from the remote node RN(1) to the remote node RN(2), the remote note RN(1) may perform encryption using an enc file in the individual communication key pool K1-2, and the remote node RN(2) may perform decryption using a dec file in the individual communication key pool K2-1. Conversely, when the remote node RN(2) performs encryption, the remote node RN(2) may perform encryption using an enc file in the individual communication key pool K2-1, and the remote node RN(1) may perform decryption using a dec file in the individual communication key pool K1-2.

Moreover, in the case where OTP cipher communication is performed from the remote node RN(1) to the center node CN, the remote node RN(1) may perform encryption using an enc file in the individual communication key pool K1-3, and the center node CN (that is, the virtual remote node RN(3)) may perform decryption using a dec file in the individual communication key pool K3-1. Conversely, when the center node CN performs encryption, the center node CN may perform encryption using an enc file in the individual communication key pool K3-1, and the remote node RN(1) may perform decryption using a dec file in the individual communication key pool K1-3.

### 2.5) Effects

As described above, according to the present example, with the provision of a virtual remote node within a center node, it is possible to treat communication between the center node and a remote node as communication between the virtual remote node and a remote node. Accordingly, management of keys for communication is simplified. In addition, since all quantum keys can be treated as logically secure keys for sharing, management of quantum keys can also be simplified.

Moreover, the center node can allocate time-divided regions for QKD key generation to be allocated to individual remote nodes, depending on the amounts of keys stored in the quantum key pools, and can even out the amounts of keys among the nodes, only by monitoring the quantum key pools. Moreover, management of encryption keys and decryption keys for use in One-Time-Pad cipher communication can be simplified. Even if the amounts of communication are asymmetric between remote nodes, an encryption key and a decryption key can be generated and shared independently of each other, depending on their consumption. Further, participation or withdrawal of a remote node in/from the quantum key distribution network can be handled only by increasing or decreasing the number of individual communication key pools in a secure key pool. Accordingly, a change in the network can be easily made.

### 3. MODIFIED EXAMPLES

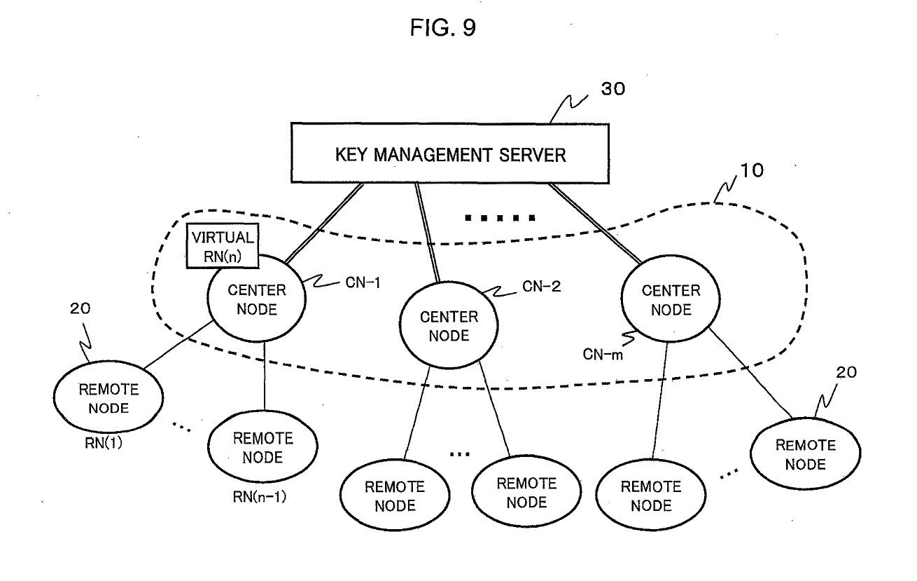

FIG. 9 is a network diagram schematically showing a physical structure of a secret communication network to which a shared random number management system according to a modification example of the present exemplary embodiment is applied. Note that similar components to those of the network shown in FIG. 1 are denoted by the same reference numerals and symbols as in FIG. 1, and a description thereof will be omitted.

Referring to FIG. 9, it is assumed that, in the center node group 10, the center nodes CN-1 to CN-m are securely connected to each other through the key management server 30 by closed communication channels (indicated by double solid lines in FIG. 9). In this case, it is sufficient to provide one virtual remote node RN(n) in the center node group 10. This is because it is possible to allow the center node group 10 including the center nodes CN-1 to CN-m to function as a center node.

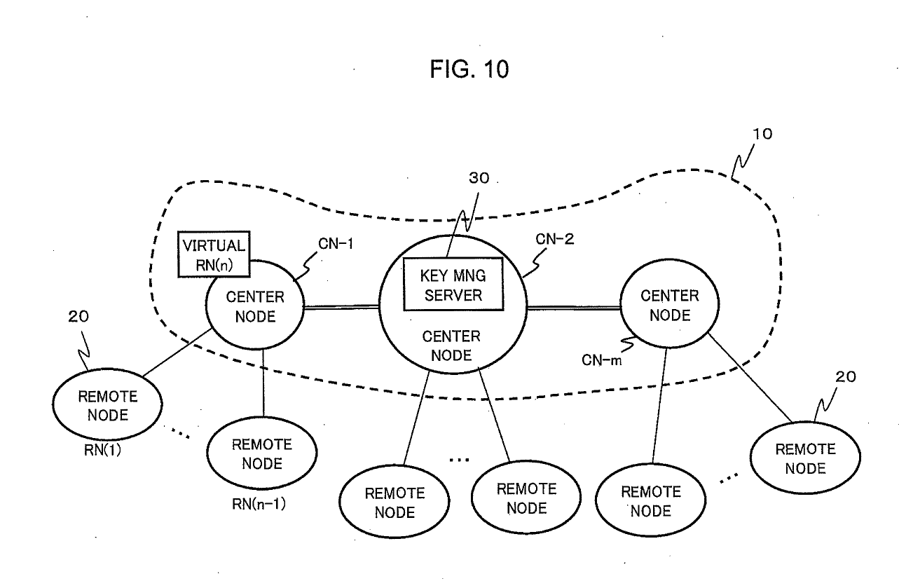

FIG. 10 is a network diagram schematically showing a physical structure of a secret communication network to which a shared random number management system according to another modification example of the present exemplary embodiment is applied. Note that similar components to those of the network shown in FIG. 1 are denoted by the same reference numerals and symbols as in FIG. 1, and a description thereof will be omitted.

Referring to FIG. 10, the key management server 30 may be incorporated within the center node group 10 or within a center node. In this case, the center nodes CN-1 to CN-m are securely connected to each other by closed communication channels, whereby a function similar to the key management server 30 can be incorporated in the center node group 10 through mutual communication.

Note that, in the above-described exemplary embodiment and examples, the quantum key distribution technique may be of any type, such as plug and play type, one-way type, or differential phase shift type. The quantum key distribution protocol is not limited to the BB84 protocol but may be the B92 or E91 protocol. The present invention is not intended to be limited to these types and protocols mentioned above.

### INDUSTRIAL APPLICABILITY

The present invention can be applied to one-to-many and many-to-many secret information communication using a shared cryptographic key distribution technology typified by the quantum key distribution (QKD) technology.

### REFERENCE SIGNS LIST

10 center node group
20 remote node
RN(1)-RN(n−1) remote node
RN(n) virtual remote node
30 key management server
101 switch section
102 quantum channel unit
103 switch section
104 classical channel unit
105 control section
106 quantum key memory
107 random number generator
108 memory for virtual remote node
201 quantum channel unit
202 classical channel unit
203 control section
204 quantum key memory

1. A system for managing random numbers shared between a center node and each of a plurality of remote nodes connected to the center node in a secret communication network, wherein
the center node comprises a virtual remote node which functions as a remote node similar to each of the plurality of remote nodes,
wherein the random numbers are managed based on random number sequences used in cipher communication between the virtual remote node and one of the plurality of remote nodes.

2. The system according to claim 1, wherein when communication between a remote node and the virtual remote node is requested, a shared random number sequence of one node of the remote node and the virtual remote node is delivered to the other node by encryption using a shared random number sequence of the other node, so that a random number sequence for cipher communication is shared between the virtual remote node and the remote node.

3. The system according to claim 1 wherein the center node further comprises a random number generation section, wherein a random number sequence shared between the center node and the virtual remote node is generated by the random number generation section.

4. The system according to claim 1, wherein the center node further comprises a first storage section for storing random number sequences shared with respective ones of the virtual remote node and the plurality of remote nodes,
wherein each of the virtual remote node and the plurality of remote nodes comprises:
a second storage section for storing a random number sequence shared with the center node; and
a third storage section for storing a communication random number sequence to be used for communication with another remote node.

5. The system according to claim 2, wherein the third storage section individually stores a communication random number sequence shared with another remote node for cipher communication.

6. The system according to claim 5, wherein the individually stored communication random number sequence is used for encryption or decryption of the cipher communication.

7. The system according to claim 1, wherein a random number sequence shared between the center node and each of the plurality of remote nodes is generated by a quantum key delivery system.

8. A method for managing random numbers shared between a center node and each of a plurality of remote nodes connected to the center node in a secret communication network, comprising:
at the center node, providing a virtual remote node which functions as a remote node similar to each of the plurality of remote nodes; and
managing the random numbers based on cipher communication between the virtual remote node and one of the plurality of remote nodes.

9. The method according to claim 8, further comprising:
when communication between a remote node and the virtual remote node is requested, delivering a shared random number sequence of one node to the other node by encryption using a shared random number sequence of the other node, so that a random number sequence for cipher communication is shared between the virtual remote node and the remote node.

10. The method according to claim 8 wherein the center node includes a random number generation means section, wherein a random number sequence shared between the center node and the virtual remote node is generated by the random number generation section.

11. The method according to claim 8, further comprising:
at the center node,
storing random number sequences shared with respective ones of the virtual remote node and the plurality of remote nodes in a first storage section;
at each of the virtual remote node and the plurality of remote nodes,
storing a random number sequence shared with the center node in a second storage section; and
storing a communication random number sequence to be used for communication with another remote node in a third storage means section.

12. The method according to claim 11, wherein a communication random number sequence shared with another remote node for cipher communication is individually stored in the third storage section.

13. The method according to claim 12, wherein the individually stored communication random number sequence is used for encryption or decryption of the cipher communication.

14. The method according to claim 8, wherein a random number sequence shared between the center node and each of the plurality of remote nodes is generated by a quantum key delivery system.

15.-18. (canceled)

19. A node connected to a plurality of remote nodes in a secret communication network, comprising:
a virtual remote node which functions as a remote node similar to each of the plurality of remote nodes; and
a management section for managing the random numbers based on random number sequences used in cipher communication between the virtual remote node and one of the plurality of remote nodes.

20. The node according to claim 19, wherein when communication between a remote node and the virtual remote node is requested, the manager delivers a shared random number sequence of one node of the remote node and the virtual remote node to the other node by encryption using a shared random number sequence of the other node, so that a random number sequence for cipher communication is shared between the virtual remote node and the remote node.

21. The nodes according to claim 19, further comprising a random number generation section, wherein a random number sequence shared between the center node and the virtual remote node is generated by the random number generation means section.

22. The nodes according to claim 19, further comprising a storage section for storing random number sequences shared with respective ones of the virtual remote node and the plurality of remote nodes.

23.-24. (canceled)
